(19) United States
(12) Patent Application Publication
(10) Pub. No.: US 2024/0274377 A1
(43) Pub. Date: Aug. 15, 2024

(54) LOAD CHANGEOVER SWITCH FOR AN ON-LOAD TAP CHANGER AND A METHOD FOR PRODUCING A LOAD CHANGEOVER SWITCH

(71) Applicant: Maschinenfabrik Reinhausen GmbH, Regensburg (DE)

(72) Inventors: Christian Hammer, Regensburg (DE); Wolfgang Albrecht, Wenzenbach (DE); Michael Schmeisser, Regensburg (DE); Christian Kotz, Schorndorf (DE)

(21) Appl. No.: 18/681,083

(22) PCT Filed: Jul. 1, 2022
(86) PCT No.: PCT/EP2022/068262

§ 371 Date: Feb. 5, 2024

(30) Foreign Application Priority Data
Aug. 9, 2021 (DE) 10 2021 120 622.7

(51) Int. Cl. H01H 9/00

(52) U.S. Cl. CPC H01H 9/0027; H01H 9/0011; H01H 9/0044

(57) ABSTRACT

A diverter switch, which is for an on-load tap-changer, includes a housing; and a carrier. The carrier has elements configured to carry out a diverter switch operation. The carrier and the elements are at least partly encapsulated in the housing.

### CROSS REFERENCE TO RELATED APPLICATIONS

This application is a U.S. National Phase application under 35 U.S.C. § 371 of International Application No. PCT/EP2022/068262, filed on Jul. 1, 2022, and claims benefit to German Patent Application No. DE 10 2021 120 622.7, filed on Aug. 9, 2021. The International Application was published in German on Feb. 16, 2023 as WO 2023/016700 A1 under PCT Article 21(2).

### FIELD

The present disclosure relates to a diverter switch for an on-load tap-changer and a method for producing such a diverter switch.

### BACKGROUND

On-load tap-changers usually have a diverter switch and a selector. The diverter switch has vacuum interrupters arranged in a compartment filled with insulating oil. The vacuum interrupters are arranged in a frame around an actuating mechanism. The use of semiconductor switching elements as alternative switching means for vacuum interrupters poses new challenges in respect of the construction and assembly of diverter switches.

### SUMMARY

In an embodiment, the present disclosure provides a diverter switch, which is for an on-load tap-changer, that includes a housing; and a carrier. The carrier has elements configured to carry out a diverter switch operation. The carrier and the elements are at least partly encapsulated in the housing.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a tap-changing transformer with a diverter switch;

FIG. 2a shows a diverter switch according to an aspect of the present disclosure;

FIG. 2b shows a sectional view of the diverter switch according to an aspect of the present disclosure; and

FIG. 3 shows a schematic sectional view of the diverter switch according to an aspect of the present disclosure.

### DETAILED DESCRIPTION

An aspect of the present disclosure provides a diverter switch for an on-load tap-changer, which is resistant to an insulating medium, has a high dielectric strength and at the same time is of simple and compact construction.

An aspect of the present disclosure provides a method for producing a diverter switch which is rapid, simple, and precise.

In accordance with a first aspect, the present disclosure provides a diverter switch for an on-load tap-changer, comprising:
a housing;
a carrier with elements for carrying out a diverter switch operation;
   wherein
the carrier with the elements are at least partly encapsulated in the housing.

By virtue of the carrier with the elements that are used for carrying out a diverter switch operation being encapsulated or potted in the housing of the diverter switch, these are protected against the insulating oil. Chemical reactions between the elements and the insulating oil are prevented. The elements and thus the entire diverter switch have a much longer service life as a result. Furthermore, by virtue of the potting, the elements are protected against vibrations and other mechanical loads from outside. The potting also increases the insulation distances between the individual elements. Flashovers are avoided, and the operating voltage level can be increased at the same time.

Within the meaning of the present disclosure, at least partly encapsulated or potted is understood to mean that the majority of the carrier and the elements is enclosed by a casting resin or silgel. However, the manufacturing process may cause individual edges or areas of the elements and of the carrier to protrude, be exposed or not be enclosed by the casting resin or silgel after the potting. This applies, for example, to the contact areas between the carrier and a connecting piece in the housing to which the carrier is fixed.

The housing can be designed in any desired way, in particular in the shape of a tank or cup. In this case, the housing can have a first region, in which the carrier is arranged. Preferably, the size of the first region is such that the carrier can be at least partly or completely arranged in the first region. In this case, the housing at least partly or completely encloses the carrier. The carrier is preferably designed as a circuit board, a printed circuit board or a printed circuit.

The carrier and the elements for carrying out a diverter switch operation are preferably at least partly encapsulated or potted with a casting resin or a silgel in the carrier. The casting resin is preferably a polyurethane casting resin or epoxy resin. The silgel is preferably designed as silicone rubber that becomes a silgel after curing.

The diverter switch can additionally comprise semiconductor switching elements and/or varistors and/or controllers and/or resistors and/or capacitors and/or MOSFETs and/or control units and/or transmitters and/or rectifiers and/or current sensors which are used as elements for carrying out a diverter switch operation.

The carrier can additionally comprise an optical communication interface and also electrical contacts, which are at least partly encapsulated or potted. The optical communication interface and also the electrical contacts are preferably potted at the interfaces to the controller and respectively to the selector only insofar as it is possible for contact to be made with these parts. Furthermore, the carrier can also have a further communication interface, which uses Bluetooth, WLAN or radio, which is at least partly encapsulated or potted. The further communication interface is preferably potted at the interfaces to the controller and respectively to the selector only insofar as it is possible for contact to be made with these parts or communication with these parts to occur.

The diverter switch is preferably connected to a controller and a selector via the optical communication interface and the electrical contacts. However, the diverter switch can also be connected to the controller and the selector via the further communication interface, i.e. Bluetooth, WLAN or radio, and the electrical contacts. The diverter switch, the selector, the controller and a motor drive form an on-load tap-changer. The on-load tap-changer is arranged in the transformer housing of a tap-changing transformer.

In accordance with a second aspect, an aspect of the present disclosure provides a method for producing a diverter switch, wherein:
in a first step, the carrier with elements for carrying out a diverter switch operation is positioned or arranged in a first region of the housing;
in a second step, the carrier is at least partly potted in the first region and thus connected to the housing;
in a third step, the housing with the potted carrier is dried.

The potting or encapsulating is preferably effected with a casting resin or a silgel, wherein the carrier is at least partly encapsulated or potted. The casting resin is preferably a polyurethane casting resin or epoxy resin. The silgel is preferably designed as silicone rubber that becomes a silgel after curing.

Aspects of the present disclosure and their advantages are described in more detail below with reference to the appended drawings.

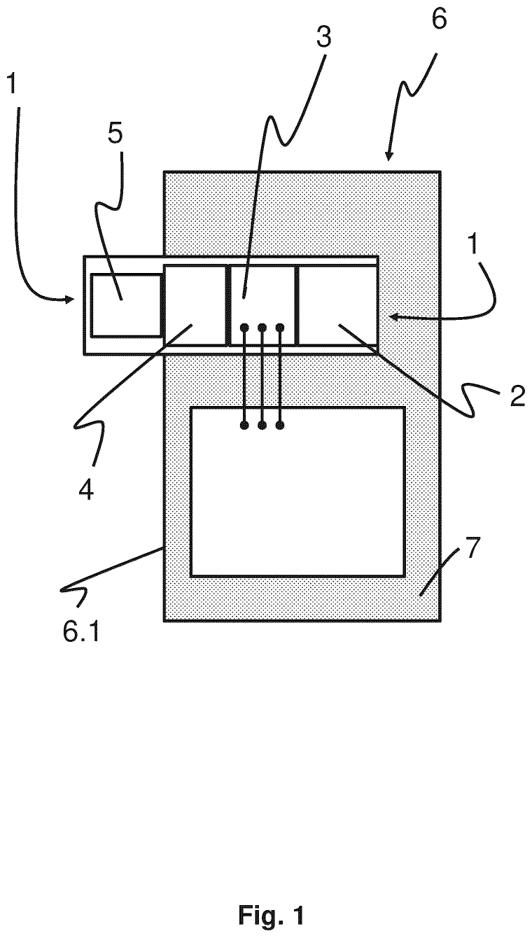

FIG. 1 shows an on-load tap-changer 1 comprising a diverter switch 2 and a selector 3, which are arranged in a tap-changing transformer 6. Furthermore, the on-load tap-changer 1 has a motor drive 4 and a controller 5. In contrast to the other parts, the controller 5 is arranged outside the transformer housing 6.1. In this case, the tap-changing transformer 6 is filled with an insulating medium 7, such as e.g. an insulating oil, which surrounds those parts of the on-load tap-changer 1 which are arranged within the transformer 6. Upon actuation of the on-load tap-changer 1, the selector 3, by way of its selector contacts, preselects a winding tap of the tap-changing transformer 6 that is to be connected up. The diverter switch 2 carries out the actual switch operation under load, which involves switching from a present winding tap to the preselected winding tap. The controller 5 controls the entire switch operation in such a way that it acts on the motor drive 4 and thus the selector 3. Furthermore, the controller 5 acts on the diverter switch 2 and the elements 32 thereof that are necessary for carrying out a diverter switch operation.

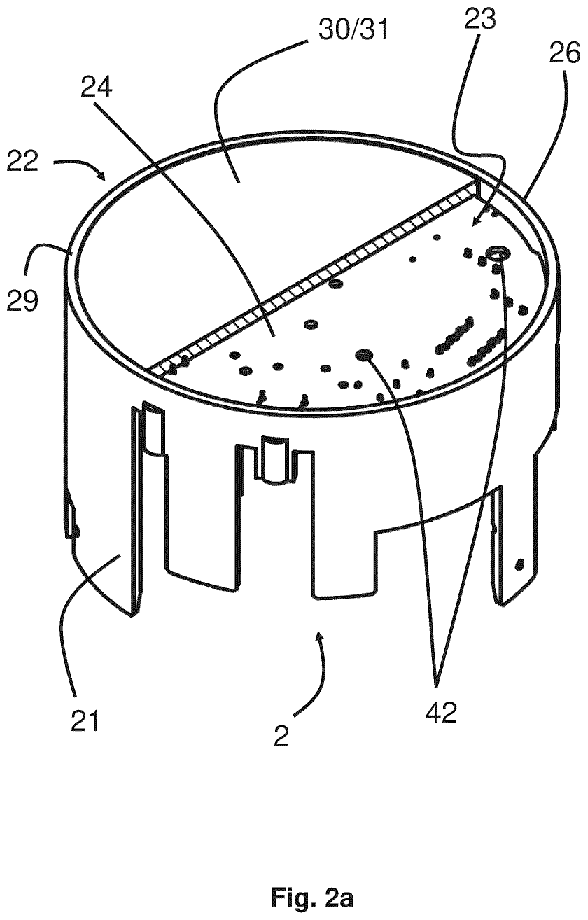

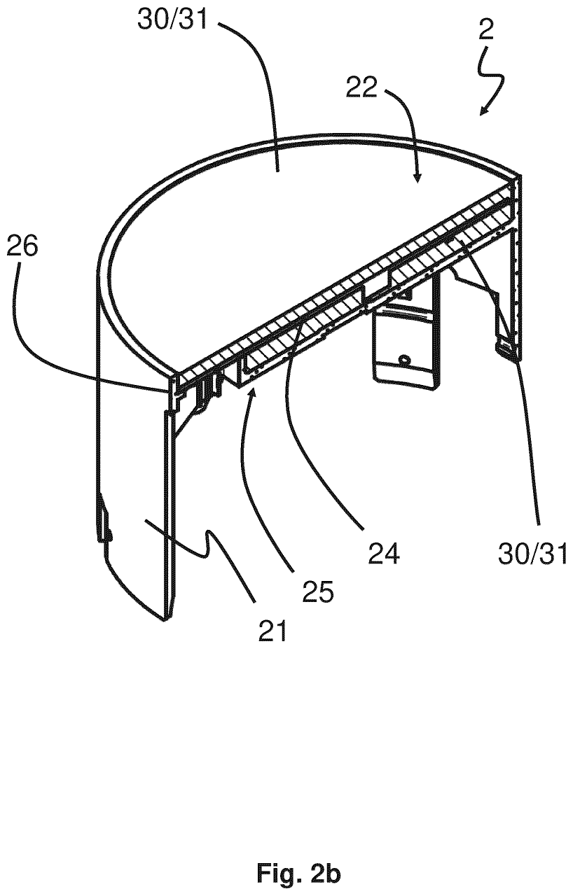

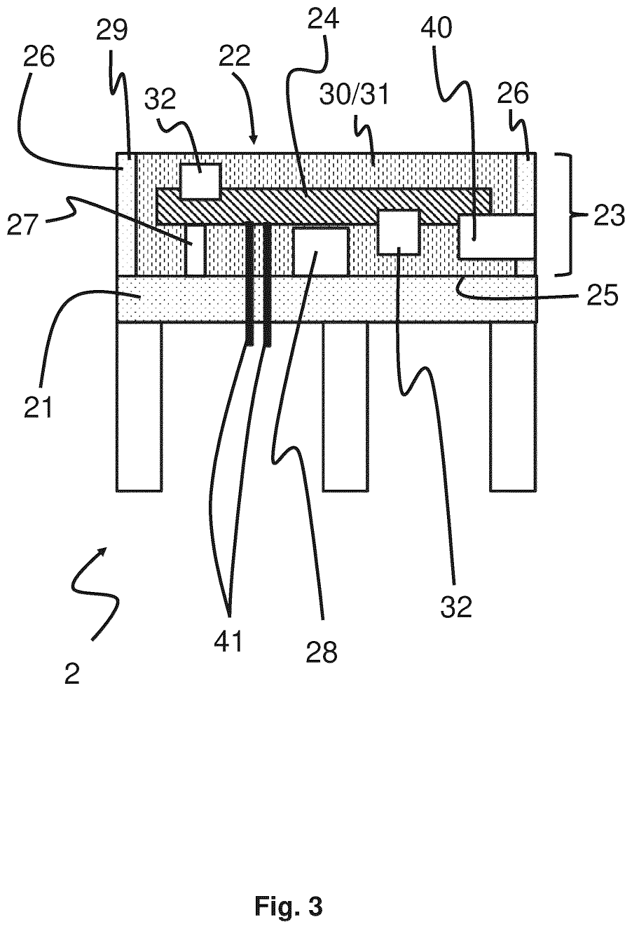

FIG. 2a, FIG. 2b and FIG. 3 show that the diverter switch 2 has a housing 21 configured in the shape of a tank. A first region 23 is formed on a first side 22 of the housing 21 in the shape of a tank, a carrier 24 being arranged in said first region. The carrier 24 is preferably designed as a circuit board. The first region 23 has a base 25 and a circular wall 26 extending around the base 25. In this case, the carrier 24 is preferably completely enclosed by the first region 23, or the carrier 24 is preferably completely, but at least partly, located within the first region. The carrier 24 is mechanically fixed in the housing 21 at defined points. Furthermore, the carrier 24 is potted or encapsulated in the first region 23 by means of a casting resin 30 or a silgel 31. The casting resin 30 can be designed as an epoxy resin or a polyurethane casting resin. The polyurethane resin preferably consists of a triisocyanate-diisocyanate mixture and a triol-diol mixture. The casting resin 30 can additionally be configured as an epoxy resin, which is a synthetic resin comprising an epoxide group.

Various elements 32 of the diverter switch 2 are arranged on or at the carrier 24. The diverter switch 2 is a switching device that is used with a selector 3 in order to switch on and off currents in branches which have already been preselected by the selector 3. In other words, a diverter switch 2 is the part of an on-load tap-changer 1 which carries out the actual switching from one winding tap to an adjacent winding tap under load. In the course of that the selector 3 is at rest such that its selector arms or selector contacts do not carry out any movement.

The elements 32 that carry out the diverter switch operation or are necessary or required therefor are situated, inter alia, on or at the carrier 24. These elements 32 are e.g. a plurality of semiconductor switching elements (IGBTs, TRIAC), varistors, resistors, capacitors, MOSFETs, control units, transmitters, rectifiers, current sensors and controllers.

Furthermore, there are situated on or at the carrier 24 at least one optical communication interface 40 and also electrical contacts 41, which are designed as flat connectors. The optical communication interface 40 and the electrical contacts 41 are likewise at least partly encapsulated or potted. They can directly adjoin the housing 21 or extend through the latter. Via the communication interface 40, the diverter switch 2 is connected to the controller 5. Via the contacts 41, the diverter switch 2 is electrically conductively connected to the selector 3 and the selector contacts thereof. The carrier 24 furthermore has cutouts 42, through which air can escape during potting. This prevents air inclusions from arising during potting between the carrier 24 and the housing 21.

The carrier 24 arranged in the housing 21 in the shape of a tank bears at least partly on the base 25 of the first region 23. Furthermore, a plurality of connecting pieces 27 can be arranged on the base 25 and enable the carrier 24 to be fixed at a distance from the base 25. The base 25 furthermore has a plurality of elevations 28 and depressions, which can likewise serve for supporting and fixing the carrier 24. In this case, the carrier 24 can bear on the elevations 28 and/or depressions. During potting, the carrier 24 and the elements 32 are preferably arranged below the outer wall edge 29, such that in the installed state they are preferably completely enclosed by the casting resin 30 or embedded therein.

The carrier 24 and the elements 32 on or at the carrier 24 are preferably completely encapsulated or enclosed by the casting resin 30 or silgel 31. The housing 21 arranged in the insulating oil 7 of the transformer 6, and hence the carrier 24 and the elements 32, are thus protected against chemical reactions with the insulating oil 7 by virtue of the potting. A further advantage of the potting is that possible contaminants in the oil no longer shorten the insulation distances and, therefore, an attenuation of the insulation distances no longer occurs. The optical communication interface 40 and also the electrical contacts 41 are preferably potted at the interfaces to the controller 5 and respectively to the selector 3 only insofar as it is always possible for contact to be made with these parts.

The method for producing or assembling the diverter switch 2 is manifested as follows. In a first step, the carrier 24 with the elements 32 for carrying out a diverter switch operation is positioned or arranged in a first region 23 of the housing 21. Here the carrier 24 can be positioned either on the base 25 of the housing 21, on at least one elevation 28 or on at least one connecting piece 27. By means of screwing or interlocking engagement with a connecting piece 27 or the housing 21, the carrier can be secured or fixed and aligned in the housing 21. In the next step, the carrier 24 together with the elements 32 is preferably completely potted. This is done by encapsulation on the part of a casting resin 30 or a silgel 31. After potting, the diverter switch 2 is dried under predefined parameters in a curing furnace. A predefined time, temperature and air humidity have to be complied with in this case. Upon the drying of the casting resin 30 or the silgel 31, firstly a connection between the carrier 24 and the housing 21 then arises, and secondly the carrier 24 is protected against the insulating oil 7.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGNS

1 On-load tap-changer
2 Diverter switch
3 Selector
4 Motor drive
5 Controller
6 Tap-changing transformer
6.1 Transformer housing
7 Insulating oil
21 Housing
22 First side of 21
23 First region of 21
24 Carrier
25 Base
26 Wall
27 Connecting pieces
28 Elevations
29 Wall edge
30 Casting resin
31 Silgel
32 Elements
40 Communication interface
41 Electrical contacts
42 Cutout

1: A diverter switch for an on load tap changer, the diverter switch comprising:
a housing; and
a carrier with comprising elements configured to carry out a diverter switch operation;
wherein the carrier and the elements are at least partly encapsulated in the housing.

2: The diverter switch as claimed in claim 1, wherein:
the housing is configured in a shape of a tank or cup;
the housing has a first region; and
the carrier is at least partly arranged in the first region.

3: The diverter switch as claimed in claim 1, wherein:
the carrier is configured as a circuit board.

4: The diverter switch as claimed in claim 1, wherein:
the carrier and the elements are at least partly or completely encapsulated or potted with a casting resin or a silgel in the housing.

5: The diverter switch as claimed in claim 1, wherein:
the elements for carrying out the diverter switch operation comprise at least one semiconductor switching element, a varistor, or a controller.

6: The diverter switch as claimed in claim 1, the diverter switch further comprising:
an optical communication interface and electrical contacts, which are at least partly encapsulated or potted and arranged on the carrier.

7: The diverter switch as claimed in claim 1, wherein;
the diverter switch is connected to a controller via an optical communication interface and is connected to a selector via electrical contacts.

8: A method for producing a diverter switch as claimed in claim 1, the method comprising:
in a first step, the carrier with elements configured to carry out a diverter switch operation is arranged in a first region of the housing;
in a second step, the carrier with the elements is at least partly potted in the first region such that the carrier is connected to the housing; and
in a third step, the housing with the potted carrier and the elements is dried.
